(19) United States
(12) Patent Application Publication
(10) Pub. No.: US 2008/0111807 A1
(43) Pub. Date: May 15, 2008

(54) Multi-output switching power supply having voltage limiting circuit

(75) Inventors: Huai-Zhu Yan, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/985,359

(22) Filed: Nov. 13, 2007

(30) Foreign Application Priority Data
Nov. 10, 2006 (TW) 95141786

(51) Int. Cl. G09G 5/00

(52) U.S. Cl. 345/211

(57) ABSTRACT

An exemplary multi-output switching power supply (2) includes a switching power supply controller (21) for generating a pulse signal; a transformer device (20) for providing a first and a second AC voltages according to the pulse signal; a first half wave rectifier (23) and a first filter circuit (25) connected in series for transforming the first AC voltage to a first DC voltage; a second half wave rectifier (24) and a second filter circuit (26) connected in series for transforming the second AC voltage to a second DC voltage; a first output (27) for providing the first DC voltage to a first load circuit (210); a feedback circuit configured for generating a feedback signal according to the first DC voltage and the second DC voltage, and providing the feedback signal to the switching power supply controller; and a voltage limiting circuit (29) connected between the first output and ground.

### FIELD OF THE INVENTION

The present invention relates to a multi-output switching power supply which can be used in an electronic device such as a liquid crystal display (LCD).

### GENERAL BACKGROUND

Multi-output switching power supplies have been widely used in all kinds of electronic devices. For example, the multi-output switching power supply is used on a main board of a computer or a notebook, or in a communication device, a mobile phone, or an LCD. A multi-output switching power supply typically includes a transformer, which provides power for a main output and at least one auxiliary output.

Referring to FIG. 3 and FIG. 4, a typical multi-output switching power supply 1 includes a transformer device 10, a switching power supply controller 11, a feedback circuit 12, a first half wave rectifier 13, a second half wave rectifier 14, a first filter circuit 15, a second filter circuit 16, a first load circuit 110, a second load circuit 112, a first output 17, and a second output 18.

The transformer device 10 includes a direct current (DC) power supply 101, a switching transistor 102, a primary winding 103, and a secondary winding 104. A control electrode 1021 of the switching transistor 102 is connected to the switching power supply controller 11 for receiving a pulse control signal. A first conducting electrode 1022 of the switching transistor 102 is connected to ground. A second conducting electrode 1023 of the switching transistor 102 is connected to one terminal of the primary winding 103. The other terminal of the primary winding 103 is connected to the DC power supply 101.

The secondary winding 104 includes a first terminal 1041 and a second terminal 1042. The first terminal 1041 of the secondary winding 104 is connected to the first output 17 via the first half wave rectifier 13 and the first filter circuit 15 in series. The second terminal 1042 of the secondary winding 104 is connected to the second output 18 via the second half wave rectifier 14 and the second filter circuit 16 in series. The first output 17 is connected to ground via the first load circuit 110. The second output 18 is connected to ground via the second load circuit 112.

The first half wave rectifier 13 includes a first branch circuit 131 having a resistor and a capacitor connected in series, and a first regulating diode 132 connected in parallel with the first branch circuit 131. A positive terminal of the first regulating diode 132 is connected to the first terminal 1041 of the secondary winding 104 of the transformer device 10. A negative terminal of the first regulating diode 132 is connected to the first filter circuit 15.

The second half wave rectifier 14 includes a second branch circuit 141 having a resistor and a capacitor connected in series, and a second regulating diode 142 connected in parallel with the second branch circuit 141. A positive terminal of the second regulating diode 142 is connected to the second terminal 1042 of the secondary winding 104 of the transformer device 10. A negative terminal of the second regulating diode 142 is connected to the second filter circuit 16.

The feedback circuit 12 includes a first input terminal (not labeled), a second input terminal (not labeled), and an output terminal (not labeled). The first input terminal of the feedback circuit 12 is connected to the first output 17 for receiving a first voltage provided to the first load circuit 110. The second input terminal of the feedback circuit 12 is connected to the second output 18 for receiving a second voltage provided to the second load circuit 112. The feedback circuit 12 generates a feedback signal according to the received first and second voltages, and provides the feedback signal to the switching power supply controller 11.

The switching power supply controller 11 is configured to generate the pulse control signal for switching on or switching off the switching transistor 102 of the transformer device 10, and adjust a duty ratio of the pulse control signal according to the received feedback signal. When the switching transistor 102 is switched on, magnetic energy is stored in the primary winding 103. When the switching transistor 102 is switched off, the magnetic energy stored in the primary winding 103 is transferred to the secondary winding 104. Therefore a first alternating current (AC) voltage is generated at the first terminal 1041 of the secondary winding 104, and a second AC voltage is generated at the second terminal 1042 of the secondary winding 104. The first AC voltage is transformed into a first direct current (DC) voltage via the first half wave rectifier 13 and the first filter circuit 15 in series, and is provided to the first output 17. The second AC voltage is transformed into a second DC voltage via the second half wave rectifier 14 and the second filter circuit 16 in series, and is provided to the second output 18. The first DC voltage is higher than the second DC voltage. For example, the first DC voltage and the second DC voltage can be equal to 12V and 5V, respectively.

In one exemplary application, the first load circuit 110 is a light load and the second load circuit 112 is a heavy load. The 5V voltage at the second output 18 connected to the second load circuit 112 is decreased to 4V, and the 12V voltage at the first output 17 connected to the first load circuit 110 maintains 12V. Thus the feedback circuit 12 generates a first feedback signal according to the voltages 4V, 12V, and provides the first feedback signal to the switching power supply controller 11. The switching power supply controller 11 increases the duty ratio of the pulse control signal according to the received first feedback signal. Therefore, a period in which the switching transistor 102 of the transformer device 10 remains in an activated state is prolonged, and the voltages respectively at the first output 17 and the second output 18 are increased.

Because the first load circuit 110 is a light load, the voltage at the first output 17 is quickly increased to 20V. Because the second load circuit 112 is a heavy load, the voltage at the second output 18 is increased to approximately 4.5V. Thus the feedback circuit 12 generates a second feedback signal according to the voltages 20V, 4.5V, and provides the second feedback signal to the switching power supply controller 11. The switching power supply controller 11 maintains the duty ratio of the pulse control signal according to the received second feedback signal. Therefore, the voltages at the first output 17 and the second output 18 maintain 20V and 4.5V, respectively.

However, the second load circuit 112 includes a number of integrated circuits (ICs), which generally only work when the 5V operation voltage is provided. Thus an electronic device such as an LCD using the multi-output switching power supply 1 is liable to operate wrongly because of the insufficient voltage at the second output 18.

It is desired to provide a new multi-output switching power supply for use in an electronic device such as an LCD which can overcome the above-described deficiencies.

### SUMMARY

In one preferred embodiment, a multi-output switching power supply includes a switching power supply controller configured for generating a pulse signal; a transformer device configured for and receiving the pulse signal and providing a first AC voltage and a second AC voltage according to the received pulse signal; a first half wave rectifier and a first filter circuit connected in series for transforming the first AC voltage to a first DC voltage; a first output configured for receiving the first DC voltage and providing the first DC voltage to a first load circuit; a second half wave rectifier and a second filter circuit connected in series for transforming the second AC voltage to a second DC voltage; a second output configured for receiving the second DC voltage and providing the second DC voltage to a second load circuit; a voltage limiting circuit connected between the first output and ground; and a feedback circuit configured for generating a feedback signal according to the first DC voltage and the second DC voltage and providing the feedback signal to the switching power supply controller.

Other novel features and advantages will become more apparent from the following detailed description when taken in conjunction with the accompanying drawings.

### BRIEF DESCRIPTION OF THE DRAWINGS

FIG. 1 is a circuit diagram of a multi-output switching power supply according to an exemplary embodiment of the present invention, the multi-output switching power supply including a transformer device.

FIG. 2 is a circuit diagram of the transformer device of FIG. 1.

FIG. 3 is a circuit diagram of a conventional multi-output switching power supply used in an LCD, the multi-output switching power supply including a transformer device.

FIG. 4 is a circuit diagram of the transformer device of FIG. 3.

### DETAILED DESCRIPTION OF PREFERRED EMBODIMENTS

Reference will now be made to the drawings to describe the present invention in detail.

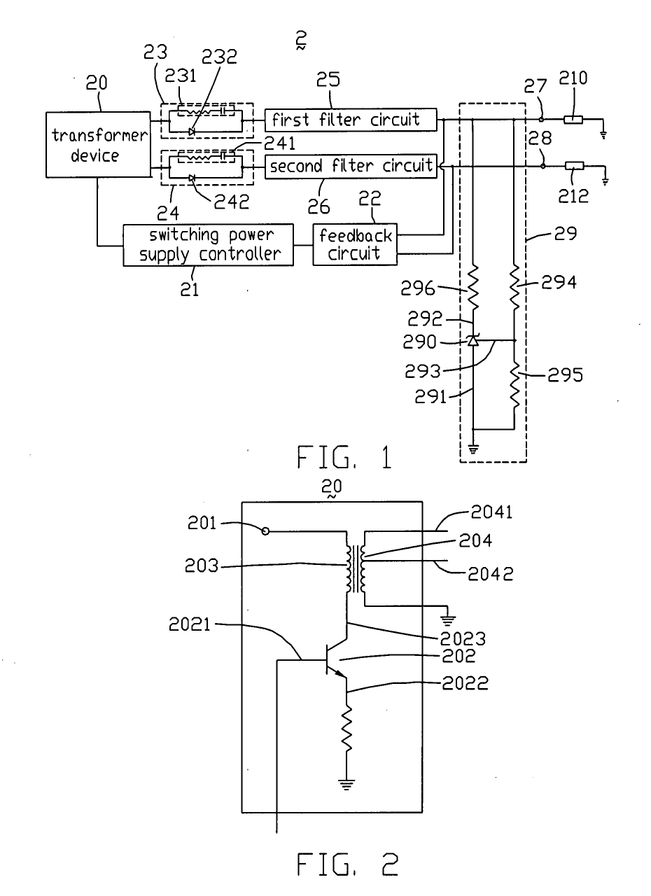

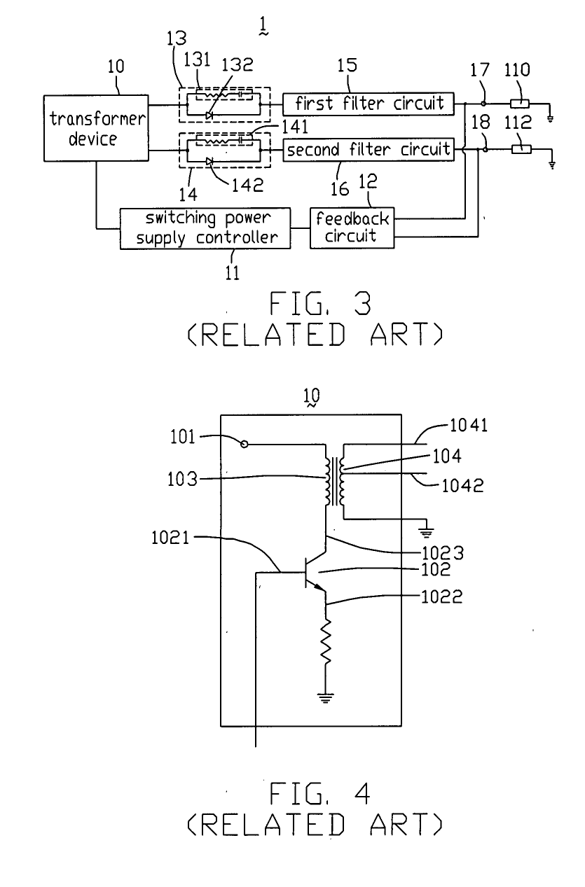

Referring to FIG. 1 and FIG. 2, a multi-output switching power supply according to an exemplary embodiment of the present invention is shown. The multi-output switching power supply 2 includes a transformer device 20, a switching power supply controller 21, a feedback circuit 22, a first half wave rectifier 23, a second half wave rectifier 24, a first filter circuit 25, a second filter circuit 26, a first load circuit 210, a second load circuit 212, a first output 27, and a second output 28.

The transformer device 20 includes a DC power supply 201, a switching transistor 202, a primary winding 203, and a secondary winding 204. A control electrode 2021 of the switching transistor 202 is connected to the switching power supply controller 21 for receiving a pulse control signal. A first conducting electrode 2022 of the switching transistor 202 is connected to ground. A second conducting electrode 2023 of the switching transistor 202 is connected to a terminal of the primary winding 203. The other terminal of the primary winding 203 is connected to the DC power supply 201.

The secondary winding 204 includes a first terminal 2041 and a second terminal 2042. The first terminal 2041 of the secondary winding 204 is connected to the first output 27 via the first half wave rectifier 23 and the first filter circuit 25 in series. The second terminal 2042 of the secondary winding 204 is connected to the second output 28 via the second half wave rectifier 24 and the second filter circuit 26 in series. The first output 27 is connected to ground via the first load circuit 210. The second output 28 is connected to ground via the second load circuit 212.

The first half wave rectifier 23 includes a first branch circuit 231 having a first resistor (not labeled) and a capacitor (not labeled) connected in series, and a first regulating diode 232 connected in parallel with the first branch circuit 231. A positive terminal of the first regulating diode 232 is connected to the first terminal 2041 of the secondary winding 204 of the transformer device 20. A negative terminal of the first regulating diode 232 is connected to the first filter circuit 25.

The second half wave rectifier 24 includes a second branch circuit 241 having a second resistor (not labeled) and a capacitor (not labeled) connected in series, and a second regulating diode 242 connected in parallel with the second branch circuit 241. A positive terminal of the second regulating diode 242 is connected to the second terminal 2042 of the secondary winding 204 of the transformer device 20. A negative terminal of the second regulating diode 242 is connected to the second filter circuit 26.

The voltage limiting circuit 29 includes a third resistor 294, a fourth resistor 295, a fifth resistor 296, and an adjustable precision shunt regulator 290. A positive electrode 291 of the adjustable precision shunt regulator 290 is connected to ground. A negative electrode 292 of the adjustable precision shunt regulator 290 is connected to the first output 27 via the fifth resistor 296. A reference electrode of the adjustable precision shunt regulator 290 is connected to the first output 27 via the third resistor 294, and is connected to ground via the fourth resistor 295. A resistance of the third resistor 294 is approximately equal to 20 kiloohms (KΩ). A resistance of the fourth resistor 295 is approximately equal to 2 KΩ. A resistance of the fifth resistor 296 is approximately equal to 200Ω.

The feedback circuit 22 includes a first input terminal (not labeled), a second input terminal (not labeled), and an output terminal (not labeled). The first input terminal of the feedback circuit 22 is connected to the first output 27 for receiving a first DC voltage provided to the first load circuit 210. The second input terminal of the feedback circuit 22 is connected to the second output 28 for receiving a second DC voltage provided to the second load circuit 212. The feedback circuit 22 generates a feedback signal according to the received first and second DC voltages, and provides the feedback signal to the switching power supply controller 21.

The switching power supply controller 21 is configured to generate the pulse control signal for switching on or switching off the switching transistor 202 of the transformer device 20, and adjust a duty cycle of the pulse control signal according to the received feedback signal. When the switching transistor 202 is switched on, magnetic energy is stored in the primary winding 203. When the switching transistor 202 is switched off, the magnetic energy stored in the primary winding 203 is transferred to the secondary winding 204. Therefore a first AC voltage is generated at the first terminal 2041 of the secondary winding 204, and a second AC voltage is generated at the second terminal 2042 of the secondary winding 204. The first AC voltage is transformed into the first DC voltage via the first half wave rectifier 23 and the first filter circuit 25 in series, and is provided to the first output 27. The second AC voltage is transformed into the second DC voltage via the second half wave rectifier 24 and the second filter circuit 26 in series, and is provided to the second output 28. The first DC voltage is higher than the second DC voltage. For example, the first DC voltage and the second DC voltage can be 12V and 5V, respectively.

In one exemplary application, the first load circuit 210 is a light load and the second load circuit 212 is a heavy load. The second load circuit 212 typically has a number of integrated circuits (ICs), which generally only work when the 5V operation voltage is provided. The 5V voltage at the second output 28 connected to the second load circuit 212 is decreased to 4V, and the 12V voltage at the first output 17 connected to the first load circuit 210 maintains 12V. Thus the feedback circuit 12 generates a first feedback signal according to the voltages 4V, 12V, and provides the first feedback signal to the switching power supply controller 21. The switching power supply controller 21 increases the duty ratio of the pulse control signal, according to the received first feedback signal. Therefore a period in which the switching transistor 202 of the transformer device 20 remains in an activated state is prolonged, and the voltages at the first output 27 and the second output 28 are both increased.

When the voltage at the first output 27 is increased to 15V, a voltage at the reference electrode 293 of the adjustable precision shunt regulator 290 is higher than a reference voltage of the adjustable precision shunt regulator 290. Thus the adjustable precision shunt regulator 290 is turned on, and the positive electrode 291 of the adjustable precision shunt regulator 290 is electrically connected to the negative electrode 293 of the adjustable precision shunt regulator 290. The first output 27 is connected to ground via the fifth resistor 296 and the activated adjustable precision shunt regulator 290, in order to maintain the voltage at the first output 27 at 15V. At the same time, the voltage at the second output 28 is increased to approximately 4.5V. The feedback circuit 22 generates a second feedback signal according to the voltages 4.5V, 15V, and provides the second feedback signal to the switching power supply controller 21. The switching power supply controller 21 continues to increase the duty ratio of the pulse control signal according to the received second feedback signal until a voltage at the second output 28 is increased to 5V. Thus the second load circuit 212 having the ICs can work normally when the 5V operation voltage is provided.

Because the multi-output switching power supply 2 includes the voltage limiting circuit 29, the multi-output switching power supply 2 can reliably output the desired 5V DC voltage to the second load circuit 212.

In various alternative embodiments, the multi-output switching power supply 2 can include more than two outputs for providing voltages to corresponding load circuits.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A multi-output switching power supply comprising:
a switching power supply controller configured for generating a pulse signal;
a transformer device configured for receiving the pulse signal and generating a first alternating current (AC) voltage and a second AC voltage according to the received pulse signal;
a first half wave rectifier and a first filter circuit connected in series for transforming the first AC voltage into a first direct current (DC) voltage;
a second half wave rectifier and a second filter circuit connected in series for transforming the second AC voltage into a second DC voltage;
a first output configured for receiving the first DC voltage and providing the first DC voltage to a first load circuit;
a second output configured for receiving the second DC voltage and providing the second DC voltage to a second load circuit;
a voltage limiting circuit connected between the first output and ground; and
a feedback circuit configured for generating a feedback signal according to the first DC voltage and the second DC voltage, and providing the feedback signal to the switching power supply controller.

2. The multi-output switching power supply as claimed in claim 1, wherein the first half wave rectifier comprises a first branch circuit and a first regulating diode connected in parallel with the first branch circuit, a positive terminal of the first regulating diode being connected to a first terminal of the transformer device, a negative terminal of the first regulating diode being connected to the first filter circuit.

3. The multi-output switching power supply as claimed in claim 2, wherein the first branch circuit comprising a first resistor and a capacitor connected in series.

4. The multi-output switching power supply as claimed in claim 1, wherein the second half wave rectifier comprises a second branch circuit and a second regulating diode connected in parallel with the second branch circuit, a positive terminal of the second regulating diode being connected to a second terminal of the transformer device, a negative terminal of the second regulating diode being connected to the second filter circuit.

5. The multi-output switching power supply as claimed in claim 4, wherein the second branch circuit comprising a second resistor and a capacitor connected in series.

6. The multi-output switching power supply as claimed in claim 1, wherein the voltage limiting circuit comprises a third resistor, a fourth resistor, a fifth resistor, and an adjustable precision shunt regulator, a positive electrode of the adjustable precision shunt regulator being connected to ground, a negative electrode of the adjustable precision shunt regulator being connected to the first output via the fifth resistor, a reference electrode of the adjustable precision shunt regulator being connected to the first output via the third resistor and being connected to the ground via the fourth resistor.

7. The multi-output switching power supply as claimed in claim 6, wherein a resistance of the third resistor is approximately equal to 20 KΩ.

8. The multi-output switching power supply as claimed in claim 6, wherein a resistance of the fourth resistor is approximately equal to 2 KΩ.

9. The multi-output switching power supply as claimed in claim 6, wherein a resistance of the fifth resistor is approximately equal to 200Ω.

10. The multi-output switching power supply as claimed in claim 1, wherein the feedback circuit comprises a first input terminal connected to the first output for receiving the first DC voltage, a second input terminal connected to the second output for receiving the second DC voltage, and an output terminal for providing the feedback signal to the switching power supply controller.

11. The multi-output switching power supply as claimed in claim 10, wherein the transformer device comprises a DC power supply, a switching transistor, a primary winding, and a secondary winding.

12. A multi-output switching power supply comprising:
a transformer device configured for generating a first alternating current (AC) voltage and a second AC voltage;
a first output configured for receiving a first direct current (DC) voltage transformed from the first AC voltage, and providing the first DC voltage to a first load circuit;
a second output configured, for receiving a second DC voltage transformed from the second AC voltage, and providing the second DC voltage to a second load circuit; and
a voltage limiting circuit connected between the first output and ground for preventing one of the DC voltages from exceeding a predetermined reference voltage.

13. The multi-output switching power supply as claimed in claim 12, wherein the voltage limiting circuit comprises a first resistor, a second resistor, a second resistor, and an adjustable precision shunt regulator, a positive electrode of the adjustable precision shunt regulator being connected to ground, a negative electrode of the adjustable precision shunt regulator being connected to the first output via the second resistor, a reference electrode of the adjustable precision shunt regulator being connected to the first output via the first resistor and being connected to the ground via the second resistor.

14. The multi-output switching power supply as claimed in claim 13, wherein a resistance of the first resistor is approximately equal to 20 KΩ.

15. The multi-output switching power supply as claimed in claim 13, wherein a resistance of the second resistor is approximately equal to 2 KΩ.

16. The multi-output switching power supply as claimed in claim 13, wherein a resistance of the second resistor is approximately equal to 200Ω.
